(19) United States
(12) Patent Application Publication
(10) Pub. No.: US 2020/0078729 A1
(43) Pub. Date: Mar. 12, 2020

(54) SEPARATION AND CO-CAPTURE OF CO2 AND SO2 FROM COMBUSTION PROCESS FLUE GAS

(71) Applicant: MEMBRANE TECHNOLOGY AND RESEARCH, INC., Newark, CA (US)

(72) Inventors: Yu Huang, Palo Alto, CA (US); Richard W. Baker, Palo Alto, CA (US); Timothy C. Merkel, San Jose, CA (US); Brice C. Freeman, Menlo Park, CA (US)

(73) Assignee: MEMBRANE TECHNOLOGY AND RESEARCH, INC., Newark, CA (US)

(21) Appl. No.: 16/469,706

(22) PCT Filed: Dec. 14, 2017
(86) PCT No.: PCT/GB2017/053742

§ 371 Date: Jun. 14, 2019

Related U.S. Application Data
(60) Provisional application No. 62/434,197, filed on Dec. 14, 2016.

(51) Int. Cl. B01D 53/75; B01D 53/22; B01D 53/14; B01D 53/50; B01D 53/78; F23J 15/00; F23J 15/02

(52) U.S. Cl. CPC B01D 53/75; B01D 53/229; B01D 53/1443; B01D 53/226; B01D 53/502; B01D 53/78; F23J 2219/40; F23J 15/02; B01D 2251/304; B01D 2251/604; F23J 2215/20; F23J 2215/50; F23J 2217/10; F23J 15/006

(57) ABSTRACT

The present invention relates to a process for concurrently removing CO₂ and SO₂ from flue gas produced by a combustion process, comprising:
(a) performing a combustion process by combusting a fuel and air in a combustion apparatus, thereby creating an exhaust stream comprising CO₂ and SO₂;
(b) compressing the exhaust stream in a first compression step, thereby producing a first compressed gas stream;
(c) providing a first membrane having a feed side and a permeate side, and being selectively permeable to CO₂ and SO₂ over nitrogen and to CO₂ and SO₂ over oxygen;
(d) passing at least a portion of the first compressed gas stream across the feed side;
(e) withdrawing from the feed side a CO₂- and SO₂-depleted residue stream;
(f) withdrawing from the permeate side at a lower pressure than the first compressed gas stream, a first permeate stream enriched in CO₂ and SO₂;
(g) passing the first permeate stream to a separation process that produces a stream enriched in CO₂ and a stream enriched in SO₂.

### REFERENCE TO RELATED APPLICATIONS

This is a U.S. national stage application based on PCT application PCT/GB2017/053742 filed Dec. 14, 2017 and claims priority to application U.S. Provisional application No. 62/434,197, filed Dec. 14, 2016, the entire disclosures of which are expressly incorporated herein by reference.

### FIELD OF THE INVENTION

The invention relates to membrane-based gas separation processes, and specifically the concurrent separation of acidic gases, such as SO₂, NOₓ, and CO₂, from combustion gases.

### BACKGROUND OF THE INVENTION

Presented below is background information on certain aspects of the present invention as they may relate to technical features referred to in the summary of the invention, but not necessarily described in detail. The discussion below should not be construed as an admission as to the relevance of the information to the claimed invention or the prior art effect of the material described.

Combustion of many fuels, such as coal, petroleum coke, or municipal solid waste produces flue gas containing nitrogen, some oxygen, carbon dioxide, and 100 to 20,000 ppm of sulfur dioxide and up to 200 ppm of NOₓ. Since the clean air act of 1990, the United States and other countries have controlled the emission of the most acidic gases: SO₂, NOₓ, and in some cases HCl and HF. In the last few years, emissions of CO₂ have also been the subject of research and regulation because of the contribution of CO₂ to global warming.

A simple block diagram of coal-burning power fitted with emission control equipment is shown in FIG. 1.

Coal feed stream (101) and air stream (102) are combined in boiler (103) that produces high temperature steam used to drive a steam turbine. Because the coal contains 0.5 to 2% sulfur and up to 1% nitrogen, the flue gas, 104, produced contains CO₂ (typically 10-15 mol %), SO₂ (0.2 to 1 mol %), and as much as 1,000 ppm NO₂. Almost all U.S. power plants have electrostatic preceptors (105) sometimes supplanted by bag house filters to control particulate emissions. U.S. coal power plants are also fitted with SO₂/NOₓ control systems (107) to remove SO₂ and NOₓ. CO₂ control systems (108) are installed on only one or two plants. The CO₂ control systems installed to date are based on amine absorption technology. Because amine absorbents react with SO₂ and NOₓ to form inert salt precipitates, the amine systems installed to date are all positioned after the particulate and SO₂/NOₓ separating systems.

In many parts of the world, however, the power plants being operated are not fitted with SO₂/NOₓ separating systems and the flue gas emitted (109) contains high levels of CO₂, SO₂ and NOₓ. Thus, it would be beneficial to develop a separation process that was able to remove SO₂, NOₓ, and CO₂ concurrently in the same separation unit.

In the embodiments of the present invention, all of these components are removed concurrently with the CO₂ from the flue gas into a single concentrate stream. In this way, the costs of CO₂, SO₂ and NOₓ removal and final segregation are significantly reduced.

The embodiments of the invention are for coal power plant flue gas, which is the largest and most important flue-gas source, but the process can also be applied to other gas streams, including but not limited to those produced by burning petroleum, coke, catalysis regeneration in FCC crackers and refineries, or flue gas emitted in cement plants, steel mills, or by municipal solid waste incinerators.

### SUMMARY OF THE INVENTION

The invention is a process for concurrently removing CO₂ and SO₂ from flue gas produced by a combustion process, comprising:

(a) performing a combustion process by combusting a fuel and air in a combustion apparatus, thereby creating an exhaust stream comprising CO₂ and SO₂;

(b) compressing the exhaust stream in a first compression step, thereby producing a first compressed gas stream;

(c) providing a first membrane having a feed side and a permeate side, and being selectively permeable to CO₂ and SO₂ over nitrogen and to CO₂ and SO₂ over oxygen;

(d) passing at least a portion of the first compressed gas stream across the feed side;

(e) withdrawing from the feed side a CO₂- and SO₂-depleted residue stream;

(f) withdrawing from the permeate side at a lower pressure than the first compressed gas stream, a first permeate stream enriched in CO₂ and SO₂;

(g) passing the second compressed gas stream to separation process that produces a stream enriched in CO₂ and a stream enriched in SO₂.

### BRIEF DESCRIPTION OF THE DRAWINGS

FIG. 1 is a schematic drawing of a basic power plant design not in accordance with the invention.

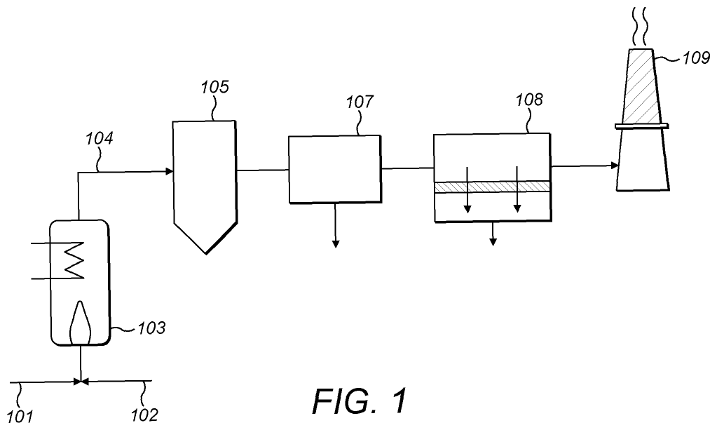

FIG. 2 is a schematic drawing of a basic embodiment of the invention.

FIG. 3 is a schematic drawing of the Holder Topsoe SNOₓ process.

FIG. 4 is a schematic drawing of a process that combines membrane separation with the Wellman-Lord process.

FIG. 5 is a schematic drawing of a low-temperature fractionation process to separate CO₂ and SO₂/NOₓ.

FIG. 6 is a schematic drawing of a basic embodiment of the invention using a one-stage membrane unit to remove CO₂, SO₂ and NOₓ from flue gas

FIG. 7 is a schematic drawing of a two-stage membrane process to remove CO₂, SO₂ and NOₓ from flue gas, producing a concentrate stream that then goes to a CO₂/SO₂ separation step.

FIG. 8 is a schematic drawing of a two-step membrane process to remove CO₂, SO₂ and NOₓ from flue gas producing a concentrated stream that is then separated into CO₂ and SO₂/NO₂ streams.

### DETAILED DESCRIPTION OF THE INVENTION

The invention is a process for concurrently removing CO₂ and SO₂ from flue gas produced by a combustion process, comprising:

(a) performing a combustion process by combusting a fuel and air in a combustion apparatus, thereby creating an exhaust stream comprising CO₂ and SO₂;

(b) compressing the exhaust stream in a first compression step, thereby producing a first compressed gas stream;

(c) providing a first membrane having a feed side and a permeate side, and being selectively permeable to CO₂ and SO₂ over nitrogen and to CO₂ and SO₂ over oxygen;

(d) passing at least a portion of the first compressed gas stream across the feed side;

(e) withdrawing from the feed side a CO₂- and SO₂-depleted residue stream;

(f) withdrawing from the permeate side at a lower pressure than the first compressed gas stream, a first permeate stream enriched in CO₂ and SO₂;

optionally, compressing the first permeate stream in a second compression step to form a second compressed gas stream; and

(g) passing the first permeate stream (or the second compressed gas stream, where appropriate) to a separation process that produces a stream enriched in CO₂ and a stream enriched in SO₂.

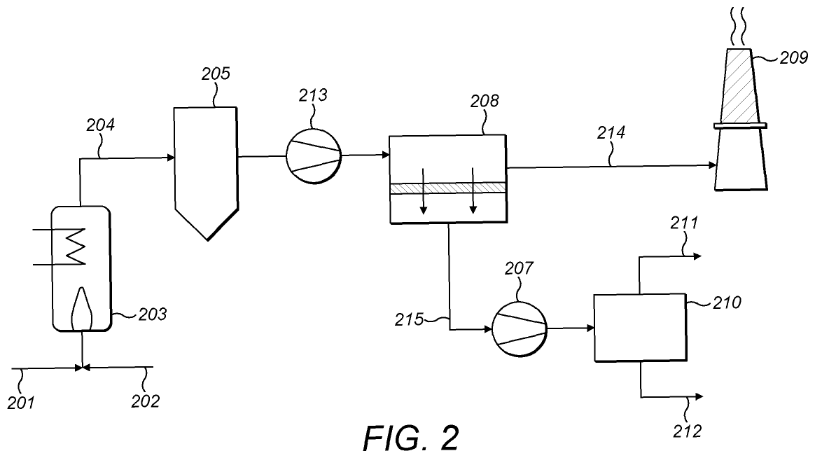

A basic embodiment of the present invention is shown in FIG. 2. As in conventional power plants, coal feed stream (201) is burnt with air stream (202) in boiler (203) to produce high-pressure stream. The flue gas produced (204) is then treated with particulate removal unit (205). The gas is then sent to membrane separation unit (208) that removes the CO₂ SO₂ and NOₓ from the gas using a membrane separation step. The driving force to perform the membrane separation step can be provided by feed gas compressor/blower (213) and/or permeate vacuum pump (207). Typical pressures generated by the compressor/blower unit are in the range of 1.1 to 3 bara. The permeate vacuum pressure is typically in the range of 0.1 to 0.3 bara. The membrane separation unit (208) is shown as a single one-stage unit, but those skilled in the art will understand that, depending on the separation required, two-stage or two-step or combination processes may also be used. Such process designs are described in U.S. Pat. No. 6,425,267, Baker et al., U.S. Pat. No. 6,648,944, Baker et al. and U.S. Pat. No. 9,005,335, Baker et al.

Treated residue gas (214) can then be sent to the chimney for disposal as vent gas (209). Membrane permeate stream (215) is typically about 10-15% of the volume of the original flue gas and is then sent to downstream CO₂, NOₓ, SOₓ separation step (210) via compressor (207) producing CO₂ concentrate stream (211) and SO₂/NOₓ concentrate stream (212).

Because the SO₂ and NOₓ concentration in the treated flue gas is 5 to 20 times more concentrated than in the original flue gas, a number of low-cost separation processes (not practical when treating the total flue gas streams) can be used.

SO₂ and NOₓ are both strong, acid gases and so wet or dry scrubbing can be used. In dry scrubbing, the reactive component is powdered CaCO₃, which reacts

CaCO₃ (solid)+SO₂ (gas) CaSO₃ (solid)+CO₂ (gas)

in wet scrubbing processes, the reactant is a Ca(OH)₂ hydrated lime. In some cases, Na(OH) is used or Ca(OH)₂ and Mg(OH)₂ mixtures. The reaction is then

Na(OH) solid+SO₂ (gas) Na₂SO₃ (solid)+H₂O (liquid)

The CaSO₃ can be further oxidized with air to produce CaSO₄, which is more marketable as gypsum for wallboards. Flue gas separation with these processes is subject to scaling and precipitation of the gypsum reactant, and careful process system design is needed to minimize these issues. Acid gas scrubbing is a simple, reliable and relatively economical process, but the products of this process are of little value.

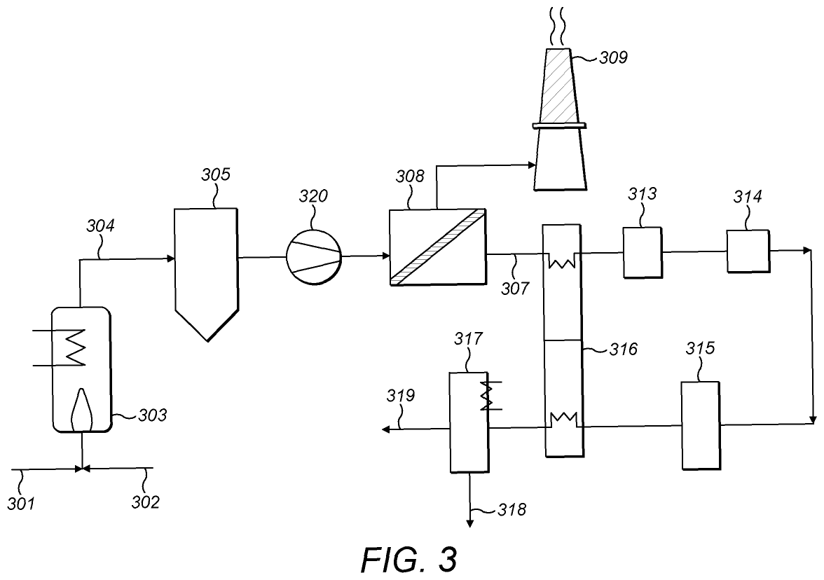

Because the membranes process shown in FIG. 2 produces a concentrated, relatively small permeate stream, a process that would not normally be economical if applied directly to flue gas can be used. The SO₂ and NOₓ concentration in the membrane concentration stream is a relatively linked process, so a process, such as the SNOₓ process developed by Holder Topsoe, can be considered. A flow diagram of this process is shown in FIG. 3.

The SNOₓ process as used in this embodiment may include the following steps:
Particulate removal (305);
Compression (320);
Membrane separation unit (308) to produce a CO₂, 502, NOₓ concentrate stream (307) and a CO₂, SO₂, NOₓ depleted flue gas vent stream (309);
Catalytic reduction of NOₓ by adding NH₃ to the gas upstream SCR DeNOₓ reactor (314);
Catalytic oxidation of SO₂ to SO₃ in oxidation reactor (315);
Cooling of the gas to about 100° C. in cooling unit (316), whereby the H₂SO₄ is condensed in condenser (317) and can be withdrawn as concentrated sulfuric acid product stream (318); and
Final concentration of the CO₂ stream, (319) for use or sequestration.

The final cooling/condensation step often uses combustion air to the boiler as the heat sink, which significantly increases the energy efficiency of the process.

In the SNOₓ process shown in FIG. 3, coal feed stream (301) is burnt with air stream (302) in boiler (303) to produce high-pressure stream. The flue gas produced (304) is then treated with particulate removal unit (305). The gas is then sent to membrane separation unit (308). CO₂, SO₂, NOₓ, concentrate stream (307) is treated by heater (313) and the NOₓ is removed by catalytically reacting with NH₃ added to the gas (NO₂+NH₃→N₂+H₂O) in catalytic reactor (314). The SO₂ is then oxidized to SO in oxidation reactor (315), which then reacts with the water vapor present. This reaction releases a good deal of heat, but when the gas is cooled the H₂SO₄ formed can be removed as a valuable product stream (318). CO₂ concentrate (319) can then be sent to final downstream purification step.

Another separation process, possible because of the relatively high SO₂ and NOₓ concentration in the gas to be treated is the Wellman-Lord sodium sulfite absorption process. The Wellman-Lord process is a regenerable process to remove sulfur dioxide from the flue gas concentrate without creating a throwaway sludge product as produced by the lime precipitation process. In the Wellman Loral process, sulfur dioxide in the concentrate gas is absorbed in a sodium sulfite solution in water forming sodium bisulfite; other components of flue gas are not absorbed. After lowering the temperature, the bisulfite is converted to sodium pyrosulfite, which precipitates.

Upon heating, the two previously described chemical reactions are reversed, sodium pyrosulfite is converted to a concentrated stream of sulfur dioxide and sodium sulfite. The sulfur dioxide can be used for further reactions (e.g., the production of sulfuric acid), and the sulfite is reintroduced into the process.

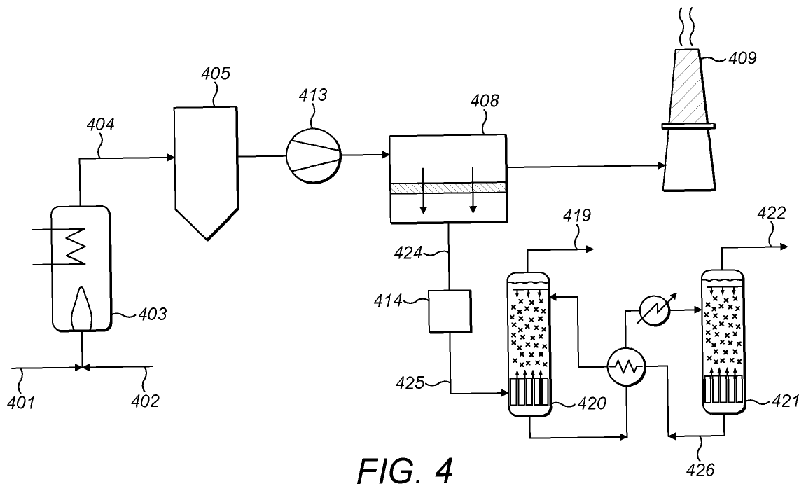

A diagram showing how the Wellman-Lord process could be combined with membrane separation of the present invention is shown in FIG. 4. Coal stream (401) is burnt with air stream (402) in boiler (403) to produce a high pressure stream. The flue gas produced (404) is then, treated with a particulate removal unit (405). The gas is then sent to a membrane separation step in membrane separation unit (408), that removes the CO₂SO₂ and NOₓ from the gas. The driving force to perform the membrane separation step can be provided by a feed gas compressor/blower (423) or a permeate-side vacuum pump, (not shown). Membrane permeate stream (424) containing CO₂, SO₂ and NOₓ is treated with ammonia in DeNOₓ catalytic reactor (414) and the NOₓ is removed via the reaction NOₓ+NH₃→N₂+H₂O. Treated steam (425) is sent to reactor (420) where the SO₂ is then removed in reaction with a sodium sulfite solution to form sodium bisulfate by the reaction Na₂SO₃+SO₂+H₂O⇄2NaHSO₃, which further reacts to form sodium pyrosulfite.

CO₂ stream (419), free of NOₓ and SO₂, is removed from the top of reactor (420). The bisulfite and pyrosulfite-containing solution is then sent to second heated reactor (421) where the SO₂ absorption reaction is reversed, producing concentrated SO₂ stream (422) and regenerated sodium sulfite stream (426), which is recycled back to the reactor (420).

Another separation process that may be used in this step is the LICONOX® (Linde Cold DeNOₓ) process. LICONOX is used for the reduction NOₓ (NO and NO₂) SOₓ in a flue gas from an oxyfuel power plant.

The CO₂ removed from the processes of the invention may be used for a number of applications, including but not limited to sequestration, enhanced oil/natural gas recovery (EOR/ENGR), enhanced coal bed methane recovery (ECBMR), submarine extraction of methane from hydrate, or for use in chemicals and fuels.

The SO₂ contained in the SO₂ concentrate stream can also be used, for example, to make sulphuric acid.

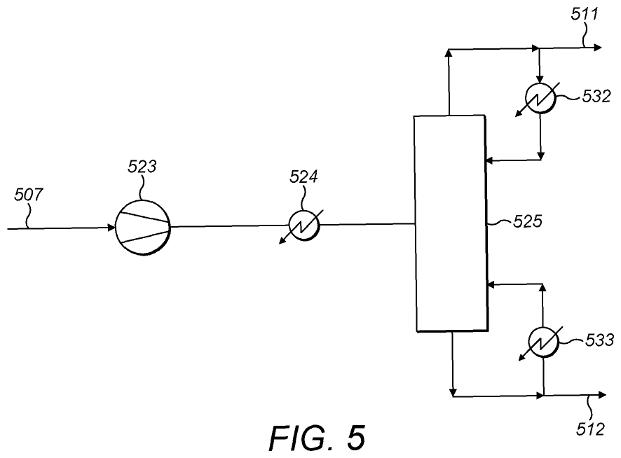

A final separation process is fractional condensation of the SO₂ and NOₓ streams. A process of this type is shown in FIG. 5. The CO₂ concentrate gas (507) from the membrane separation is compressed in stages by compressor (523) to a pressure of 25 to 30 bar, and then cooled to about −15 to −20° C. by cooler (524). SO₂ and NOₓ are considerably more condensable than CO₂, nitrogen and oxygen that might be present in the gas, so when this gas is sent to fractionating column (525). The fractionating column is fitted with a partial condenser unit (532) at the top and a reboiler unit (533) at the bottom. The condensable, SO₂ and NOₓ components are removed as liquid condensate (512) while the CO₂ and other light gases stripped of the bulk of the SO₂ and NOₓ are removed as overhead vapor (511).

### EXAMPLES

### Example 1: Embodiment of FIG. 5

An example calculation to show the efficacy of the approach described in FIG. 5 is shown in Table 1. Stream (507) contains about 80% CO₂, 1% SO₂ and 0.1% NOₓ. After fractionating in a ten-stage column, the bottom liquid product containing 97% of the SO₂ and essentially all of the NOₓ is removed as a liquid for conversion to sulfuric acid or other product, while the CO₂ concentrates stream containing 89% of the original CO₂ content is ready for final fraction and sequestration or use.

TABLE 1

| | | | SO₂/NOₓ |
|---|---|---|---|
| | | | Concentrate |
| | Stream 507 | Stream 511 | Stream 512 |
| Temp (° C.) | 30 | −16 | −1 |
| Pressure (bar) | 1.0 | 30 | 30 |

Gas Composition (mol %)

| | | | |
|---|---|---|---|
| CO₂ | 80.0 | 79.1 | 88.9 |
| N₂ | 15.1 | 16.7 | 0.0 |
| O₂ | 3.8 | 4.2 | 0.0 |
| SO₂ | 1.0 | 0.03 | 10.1 |
| NOₓ | 0.1 | 0.00005 | 1.0 |

For this process to be successful, membranes are required that selectivity permeate CO₂, SO₂ and NOₓ, and are stable in the pressure of these components. We have found a number of membranes that meet this requirement.

A preferred type of membrane that could be used is a composite membrane made from polar rubbery polymers, such as Pebax® or Polaris™ membranes. Both of these polymers include blocks of polyethylene oxide in their structures that make the membranes very permeable to gases, such as CO₂, NO₂SO₂, and relatively impermeable to other gases, such as oxygen and nitrogen. Typical selectivities that are possible with flue gas are:

SO₂/N₂: 50-100

NOₓ/N₂: 50-100

CO₂/N₂: 20-50

O₂/N₂: 2.

This type of membrane is described, for example in papers by H. Lin and Freeman, J. Molec Struct, vol. 739, pp 57-74 (2005), and Lin, et al., Macromolecules, vol. 38, pp 8381-8393 (2005). Even more selective membranes can be used if needed, such as the membrane incorporating amine groups and working by facilitated transport, for example, Zhao, et al., J. Mater. Chem A. vol. 1, pp 246-249 (2013), Zou and Ho, J. Memb. Sci vol. 286, pp 310-321 2006), and Chen and Ho, J. memb. Sci. vol. 514, pp 376-384 (2016) In general, these polar rubbery membranes have good selectivities for CO₂ over nitrogen, SO₂ and NO₂ because they are more condensable than CO₂ and have even higher selectivities over nitrogen. Typically SO₂ and NOₓ are 2 to 3 times more permeable than CO₂. This means that a membrane process designed to remove, for example 50% of the CO₂ from the flue gas stream will generally remove 70 to 80% of the SO₂ and NO₂ at the same time.

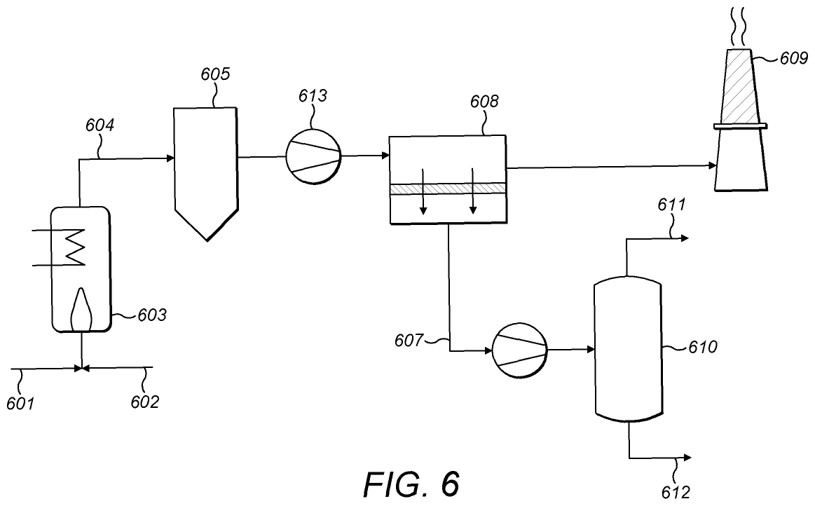

A number of membrane processes to separate CO₂ from flue gas have been suggested. These processes, if fitted with the right membrane that permeate NOₓ and SO₂, as well as CO₂, could be used in the total process. Examples of certain embodiments of potential process designs are shown below in FIGS. 6-8.

### Example 2: Embodiment of FIG. 6

A calculation was performed to model the performance of the process of the invention shown in FIG. 6, which shows a simple one-stage process. Vacuum operation is generally preferred because less energy is used. Generally, they are most economical at CO₂ removals from flue gas of less than 60% In the one-stage membrane process shown in FIG. 6, coal feed stream (601) is burnt with air stream (602) in boiler (603) to produce high-pressure stream. The flue gas produced (604) is then treated with particulate removal unit (605). The gas is then sent to compressor (613) and then sent on to the single membrane separation unit (608), producing CO₂, SO₂, NOₓ concentrate stream (607) from flue gas (604). This design is best used for partial removal of CO₂ from flue gas, that is removal of about 50% of the CO₂ content. Such partial removal is useful since it reduces overall CO₂ emissions in emitted gas (609) to the atmosphere from 800 g CO₂/KWe of electricity produced to about 400 g CO₂/KWe of electricity produced, which is about the same level of CO₂ emissions from natural gas power turbines, a good target emission rate for a coal power plant. The performance of this type of one stage system is shown in Table 2. The membrane in the example calculation removes 50% of the CO₂ from the feed flue gas (604) producing a concentrate in which the CO₂ concentration is enriched from 15% to 73%. At the same time, the membrane removes 76% of the SO₂ and NOₓ into the CO₂, SO₂, NOₓ concentrate permeate stream (607) enriching the SO₂ concentration from 1.0% to 7.5% and the NOₓ concentration from 0.1% to 0.75%. Final separation of the CO₂, SO₂, NOₓ concentrate stream (607) into SO₂ and NOₓ stream (612) and CO₂ stream (611) by fractionating column (610) described earlier in FIG. 5 (525) is far easier than treating raw flue gas.

TABLE 2

| | Flue Gas Feed | CO₂ Depleted Gas | CO₂ Concentrate |
|---|---|---|---|
| | (604) | (609) | (607) |
| Mass (Kg/h) | 10,000 | 8,590 | 1,410 |
| Pressure (Bar) | 3.0 | 3.0 | 0.1 |

Gas Composition (Mol %)

| | | | |
|---|---|---|---|
| CO₂ | 15.0 | 8.4 | 73.3 |
| N₂ | 80.9 | 88.2 | 17.2 |
| O₂ | 3.0 | 3.2 | 1.3 |
| SO₂ | 1.0 | 0.26 | 7.5 |
| NO₂ | 0.1 | 0.026 | 0.75 |

The membrane used for this process has a CO₂ permeance of 1,000 gpu, an SO₂ permeance of 3,000 gpu, an NOₓ permeance of 3,000 gpu, a nitrogen permeance of 25 gpu and an oxygen permeance of 50 gpu. Membranes with these permeances and selectivities are well known.

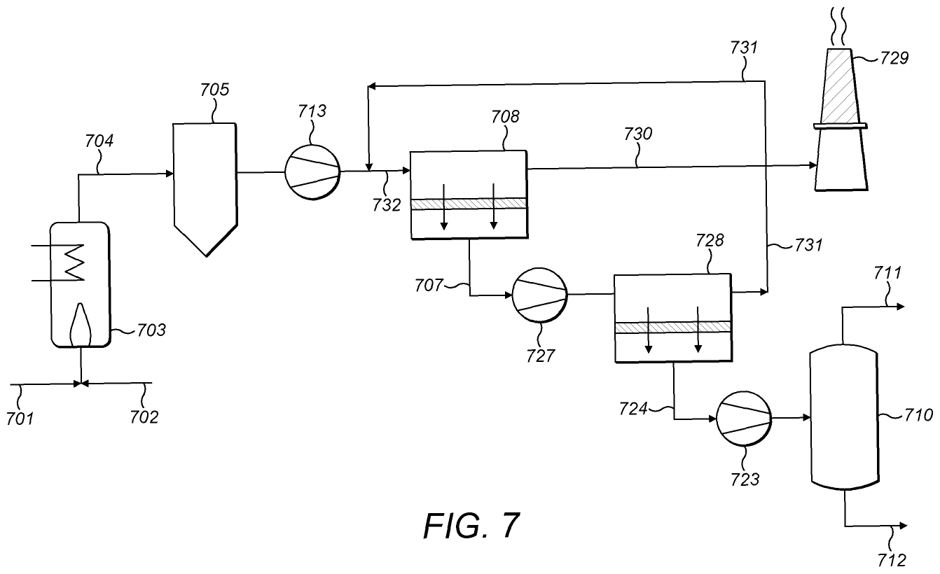

### Example 3: Embodiment of FIG. 7

FIG. 7 is a schematic of a two-stage removal, also most economical at CO₂ removals of 60% or less. The two-stage process, by twice concentrating the CO₂/SO₂/NOₓ stream, produces a small volume of very concentrated gas that is very economically treated by the Wellman-Lord process, for example. In FIG. 7, coal feed stream (701) is burnt with air stream (702) in boiler (703) to produce high-pressure steam. The flue gas produced (704) is then treated with particulate removal unit (705) and sent to a first-stage membrane separation unit (708). A CO₂, SO₂, and NOₓ concentrate stream (707) is sent to second stage membrane unit (728) and a retentate stream (730) is released as vent stream (729). The permeate from the second stage membrane separation unit (724) is sent to fractionating column (710) to produce a CO₂ concentrate stream (711) and an SO₂/NOₓ concentrate stream (712). The retentate (731) from the second stage membrane separation unit (728) is sent back to join the stream (732) entering the first stage membrane unit (708). An example calculation to illustrate the performance of the design shown in FIG. 7 is shown in Table 3. The membrane used has the same properties as that used in the example shown in FIG. 6. By using two sequential membrane stages, the concentration of CO₂, SO₂ and NOₓ in the final second stage concentrate can be increased. This reduces the size and cost of the final of CO₂, SO₂ and NOₓ separation step (710). Also because the second stage membrane separation unit (728) performs an additional stage of separation, the need for the first stage membrane separation unit (708) to perform a very good separation can be relaxed. This means instead of using compressor/blower (713) to increase the pressure of the gas to be treated to 2 to 3 bar, a simple 1:1 bar blower can be used. This increases the membrane area needed but substantially reduces the energy consumption of compressor/blower (713).

TABLE 3

| | | First | Second | |
|---|---|---|---|---|
| | Flue Gas | Membrane | Membrane | Treated Flue |
| | (704) | Permeate (707) | Permeate (724) | Gas (709) |
| Gas Pressure | 1.1 | 0.1 | 0.1 | 1.9 |
| (Bar) | | | | |

Gas Composition (mol %)

| | | | | |
|---|---|---|---|---|
| CO₂ | 15.0 | 66.5 | 88.0 | 8.5 |
| N₂ | 80.9 | 25.6 | 3.1 | 87.9 |
| O₂ | 3.0 | 1.86 | 0.43 | 3.2 |
| SO₂ | 1.0 | 5.5 | 7.7 | 0.40 |
| NO₂ | 0.1 | 0.55 | 0.77 | 0.040 |

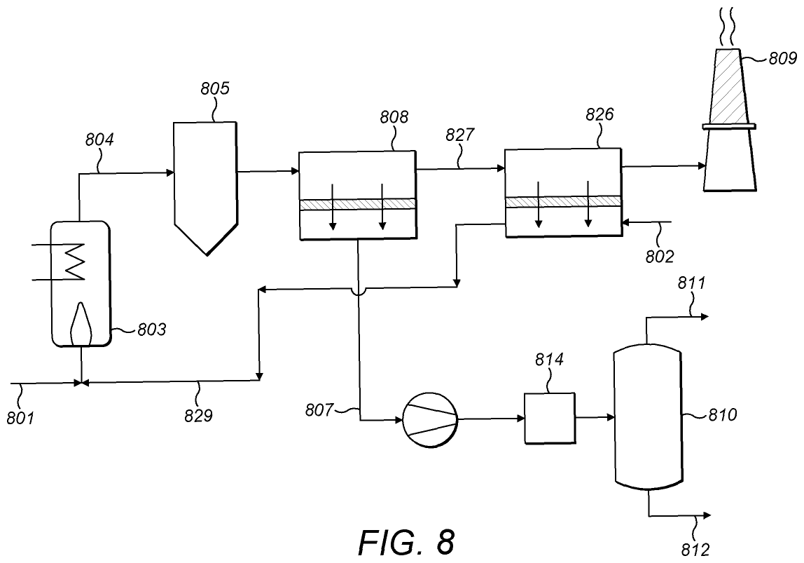

Another membrane separation process that can be used is the MTR membrane contactor design shown in FIG. 8. This design is described in U.S. Pat. No. 8,016,923, Baker et al., and U.S. Pat. No. 8,025,715, Wijamns et al. The process is also described in a paper by Merkel et al, J. Memb. Sci. v359 (2010) pp. 126-139. It generally produces a CO₂, SO₂, NOₓ concentrated permeate stream that has one-tenth of the volume of the flue gas stream. Downstream removal of NOₓ and end-stage separation of CO₂ and SO₂ is then relatively economical. Coal feed stream (801) and air stream (829) are burnt in boiler (803) to make steam. The resulting flue gas (804), mostly consisting of nitrogen, also contains CO₂, SO₂, and NOₓ produced by the combustion process. This flue gas after particulate removal (805) is pressurized to 1.1 to 2 bara with compressor/blower (not shown) and sent to a two-step membrane separation process (808) and (826). In first membrane separation unit (808), a CO₂, SO₂, and NOₓ concentrate stream (807) is produced. Typically about 50 to 60% of the CO₂ in flue gas (804) is removed in this step. Retentate gas from membrane unit (808) is then sent as feed stream (827) to second membrane separation unit (826). There may be a small pressure difference across membrane in unit (826) but most of the separation driving force is generated by flow of air (802) across the permeate side of the membrane. Because of the air flow, there is a concentration difference across the membrane and CO₂, SO₂, and NOₓ present in feed stream (827) permeates into the air stream (802). There is also some permeation of oxygen from air stream (802) into feed stream (827), but because the membrane is relatively impermeable to oxygen, this flow is small. The result of this operation is to strip much of the CO₂, SO₂, and NOₓ in stream (802) that eventually becomes combination air to boiler stream (829). This increases the CO₂, SO₂, and NOₓ content in flue gas (804) making the separation process easier while depleting the concentration of these components in the gas finally emitted (809).

1. A process for concurrently removing CO₂ and SO₂ from flue gas produced by a combustion process, comprising:
(a) performing a combustion process by combusting a fuel and air in a combustion apparatus, thereby creating an exhaust stream comprising CO₂ and SO₂;
(b) compressing the exhaust stream in a first compression step, thereby producing a first compressed gas stream;
(c) providing a first membrane having a feed side and a permeate side, and being selectively permeable to CO₂ and SO₂ over nitrogen and to CO₂ and SO₂ over oxygen;
(d) passing at least a portion of the first compressed gas stream across the feed side;
(e) withdrawing from the feed side a CO₂- and SO₂-depleted residue stream;
(f) withdrawing from the permeate side at a lower pressure than the first compressed gas stream, a first permeate stream enriched in CO₂ and SO₂;
(g) passing the first permeate stream to a separation process that produces a stream enriched in CO₂ and a stream enriched in SO₂.

2. The process of claim 1, wherein between steps (f) and (h) there is a further step (f′) of compressing the first permeate stream in a second compression step.

3. The process of claim 1, wherein the exhaust stream comprises flue gas from a coal-fired power plant.

4. The process of claim 1, wherein the separation process is a Ca(OH)₂, Na(OH) scrubbing step.

5. The process of claim 1, wherein the separation step is an absorption process.

6. The process of claim 5, wherein the absorption process is a Wellman-Lord process.

7. The process of claim 1, wherein volume of the first permeate stream is less than about one-fifth of the volume of the exhaust stream

8. The process of claim 1, wherein the exhaust stream further comprises NOₓ.

9. The process of claim 8, wherein the first membrane is also selectively permeable to NOₓ over nitrogen and to NOₓ over oxygen.

10. The process of claim 9, wherein the stream enriched in SO₂ is also enriched in NOₓ.

11. The process of claim 1, wherein the exhaust stream further comprises particulate matter.

12. The process of claim 11, further comprising the step of removing the particulate matter from the exhaust gas in a particulate removal step prior to step (b).

13. The process of claim 1 further comprising the steps of:
(i) providing a second membrane having a feed side and a permeate side, and being selectively permeable to CO₂, SO₂, and NOₓ over nitrogen and to CO₂, SO₂, and NOₓ over oxygen;
(j) passing at least a portion of the vent stream across the feed side;
(k) passing air, oxygen-enriched air, or oxygen as a sweep stream across the permeate side;
(l) withdrawing from the feed side a CO₂-depleted vent stream;
(m) withdrawing from the permeate side a second permeate comprising oxygen and carbon dioxide; and
(n) passing the second permeate stream to step (a) as at least part of the air used in step (a).

14. A process for concurrently removing CO₂ and SO₂ from flue gas produced by a combustion process, comprising:
(a) performing a combustion process by combusting a of a fuel and air in a combustion apparatus, thereby creating an exhaust stream comprising CO₂ and SO₂;
(b) compressing the exhaust stream in a first compression step, thereby producing a first compressed gas stream;
(c) providing a first membrane having a feed side and a permeate side, and being selectively permeable to CO₂ and SO₂ over nitrogen and to CO₂ and SO₂ over oxygen;
(d) passing at least a portion of the first compressed gas stream across the feed side;
(e) withdrawing from the feed side a CO₂- and SO₂-depleted vent stream;
(f) withdrawing from the permeate side a first permeate stream at a lower pressure than the feed side pressure enriched in CO₂ and SO₂;
(g) compressing the first permeate stream in a second compression step, thereby producing a second compressed gas stream;
(h) providing a second membrane having a feed side and a permeate side, and being selectively permeable to CO₂ and SO₂ over nitrogen and to CO₂ and SO₂ over oxygen;
passing at least a portion of the second compressed gas stream across the feed side;
(j) withdrawing from the feed side a CO₂- and SO₂-depleted residue stream;
(k) withdrawing from the permeate side a second permeate stream enriched in CO₂ and SO₂;
(l) passing the residue stream back to a point in the process upstream of step (c);
(m) compressing the second permeate stream in a third compression step, thereby producing a third compressed gas stream; and
(n) passing the third compressed gas stream to separation process that produces a stream enriched in CO₂ and a stream enriched in SO₂.

15. The process of claim 14, wherein the exhaust stream comprises flue gas from a coal-fired power plant.

16. The process of claim 14, wherein the separation process is a Ca(OH)₂, Na(OH) scrubbing step.

17. The process of claim 14, wherein the separation step is an absorption process.

18. The process of claim 17, wherein the absorption process is a Wellman-Lord process.

19. The process of claim 14, wherein volume of the second permeate stream is less than about one-tenth of the volume of the exhaust stream

20. The process of claim 14, wherein the exhaust stream further comprises NOₓ.

21. The process of claim 20, wherein the first membrane is also selectively permeable to NOₓ over nitrogen and to NOₓ over oxygen.

22. The process of claim 21, wherein the stream enriched in SO₂ is also enriched in NOₓ.

23. The process of claim 14, wherein the exhaust stream further comprises particulate matter.

24. The process of claim 23, further comprising the step of removing the particulate matter from the exhaust gas in a particulate removal step prior to step (b).
